(19) United States
(12) Patent Application Publication
(10) Pub. No.: US 2019/0347698 A1
(43) Pub. Date: Nov. 14, 2019

(54) VALUE MANAGEMENT SERVER, VALUE MANAGEMENT METHOD, AND NON-TRANSITORY COMPUTER READABLE MEDIUM RECORDING A PROGRAM

(71) Applicants: Tamio ARAI, Tokyo (JP); FANUC CORPORATION, Yamanashi (JP)

(72) Inventors: Masaru ODA, Yamanashi (JP); Shinsuke SAKAKIBARA, Yamanashi (JP); Tamio ARAI, Tokyo (JP)

(21) Appl. No.: 16/381,570

(22) Filed: Apr. 11, 2019

(30) Foreign Application Priority Data
May 9, 2018 (JP) 2018-090331

(51) Int. Cl. G06Q 30/02

(52) U.S. Cl. CPC G06Q 30/0278; G06Q 10/20

(57) ABSTRACT

In a spare part sharing system, a server includes: a storage unit that stores at least the company codes of registered enterprises and the identification information and the quantities of registered spare parts; a value calculation unit that calculates, based on at least the identification information of the registered spare parts, the values of the registered spare part; a first output unit that outputs the values calculated by the value calculation unit as the usable values of the registered enterprises to the registered enterprises; and a second output unit that outputs the spare parts that are stored in the storage unit and that are registered as shared spare parts by all the enterprises.

This application is based on and claims the benefit of priority from Japanese Patent Application No. 2018-090331, filed on 9 May 2018, the content of which is incorporated herein by reference.

### BACKGROUND OF THE INVENTION

### Field of the Invention

The present invention relates to a value management server, a value management method, and a non-transitory computer readable medium recording a program that manage the values of goods such that devices and/or components possessed by each enterprise are set as goods that can be used by other enterprises.

### Related Art

Conventionally, for example, in a factory or the like that uses an industrial machine such as a machine tool or an industrial robot, when a device and/or a component that is a portion of the device (hereinafter the device and/or the component is also referred to as the part) that forms the industrial machine is, for example, broken, the part is ordered. For example, patent document 1 discloses a component order system for ordering online a component of a device within the factory from a component supplier outside a factory. Patent document 2 discloses an automatic component order method of a molding machine for timely and reliably ordering a consumable item and a consumable component of the molding machine.

For a part among parts that has a relatively high possibility that the part will not be able to be used, a consumable item, and the like, spare items (hereinafter the spare items are also referred to as spare parts) are previously stored in a factory or the like, and when they cannot be used, the spare parts that are stored are used.
Patent Document 1: Japanese Unexamined Patent Application, Publication No. 2003-1.73379
Patent Document 2: Japanese Unexamined Patent Application, Publication No. 2005-258585

### SUMMARY OF THE INVENTION

In general, a part is not ordered until the part cannot be used. Hence, it takes time to deliver the part, and thus in the meantime, a device cannot be operated. When the spare part is previously possessed, even if the part cannot be used, the spare part is used, and thus it is possible to rapidly operate the device. However, since a storage place for the spare part is needed, it is unrealistic to possess spare items for all parts. When spare parts are possessed for some parts, it is problematic to determine for what parts spare parts are to be possessed. Furthermore, when a part whose spare part is not possessed cannot be used, the part is ordered and is waited for until the part is delivered.

An object of the present invention is to provide a value management server, a value management method, and a non-transitory computer readable medium recording a program in which parts (devices and/or components) possessed as goods by an enterprise serving as an economic entity are registered as goods that can be used by other enterprises, in which the values of the goods are managed and in which thus within a range of the total sum of the values of all the goods registered by the enterprise the goods registered by the other enterprises can be used.

(1) A value management server (for example, a “server 1” that will be described later) of the present invention registers devices and/or components possessed by a plurality of economic entities (for example, “enterprises” that will be described later) as goods (for example, “spare parts” that will be described later) that can be used by all the economic entities and manages the devices and/or components, and includes: a storage unit (for example, a “storage unit 20” that will be described later) that stores at least the identification information of the registered economic entities and the identification information and the quantities of the registered goods; a value calculation unit (for example, a “value calculation unit 13” that will be described later) that calculates, based on at least the identification information of the registered goods, the values of the registered goods; a first output unit (for example, a “first output unit 14” that will be described later) that outputs the values calculated by the value calculation unit as the usable values of the registered economic entities to the registered economic entities; and a second output unit (for example, a “second output unit 15” that will be described later) that outputs the goods that are stored in the storage unit and that are registered as shared goods by all the economic entities.

(2) Preferably, the value management server described in (1) includes a ratio calculation unit (for example, a “ratio calculation unit 12” that will be described later) that calculates a ratio corresponding to the quantity of a good having the same identification information as the registered good in the goods registered as the shared goods by all the economic entities, and the value calculation unit calculates the value of the registered good from at least the identification information of the registered good and the ratio.

(3) Preferably, in the value management server described in (1) or (2), the storage unit further stores information on the storage places of the registered goods, and the second output unit further outputs the information on the storage places of the goods.

(4) Preferably, the value management server described in any one of (1) to (3) includes a notification unit (for example, a “notification unit 16” that will be described later) that provides, when a usage request for the good is received from the economic entity that desires to use the good, notification to the economic entity that possesses the good.

(5) Preferably, in the value management server described in (4), the notification unit provides the notification to the economic entity that possesses the good on condition that the value of the good for that the usage request received does not exceed the usable value of the goods possessed by the economic entity that desires to use the good.

(6) Preferably, in the value management server described in any one of (1) to (5), a usage request for the good from the economic entity that possesses the good to the economic entity that desires to use the good is a loan of the good from the economic entity that possesses the good to the economic entity that desires to use the good.

(7) Preferably, in the value management server described in any one of (1) to (6), the economic entity that possesses the good and the economic entity that desires to use the good are made to conceal each other.

(8) Preferably, the value management server described in (7) includes an IOU receiving unit (for example, a “borrowing processing unit 17” that will be described later) that receives, from the economic entity that desires to use the good, an IOU for the good.

(9) Preferably, the value management server described in (8) includes an IOU issuing unit (for example, a “borrowing processing unit 17” that will be described later) that issues the IOU to the economic entity that possesses the good.

(10) A value management method of the present invention is a value management method of using a computer (for example, a “server 1” that will be described later) so as to register devices and/or components possessed by a plurality of economic entities as goods that can be used by all the economic entities and to manage the devices and/or components, and includes: a storage step of storing at least the identification information of the registered economic entities and the identification information and the quantities of the registered goods; a value calculation step of calculating, based on at least the identification information of the registered goods, the values of the registered goods; a first output step of outputting the values calculated in the value calculation step as the usable values of the registered economic entities to the registered economic entities; and a second output step of outputting the goods that are stored in the storage step and that are registered as shared goods by all the economic entities, and all the steps are performed by the computer.

(11) A non-transitory computer readable medium recording a program of the present invention makes a computer function as: a storage means that stores at least the identification information and the quantities of goods where devices and/or components possessed by a plurality of economic entities are registered as the goods that can be used by all the economic entities and the identification information of the economic entities that register the goods; a value calculation means that calculates, based on at least the identification information of the registered goods, the values of the registered goods; a first output means that outputs the values calculated by the value calculation means as the usable values of the registered economic entities to the registered economic entities; and a second output means that outputs the goods that are stored in the storage means and that are registered as shared goods by all the economic entities.

According to the present invention, it is possible to provide a value management server, a value management method, and a non-transitory computer readable medium recording a program in which parts devices and/or components) possessed as goods by an enterprise serving as an economic entity are registered as goods that can be used by other enterprises, in which the values of the goods are managed and in which thus within a range of the total sum of the values of all the goods registered by the enterprise the goods registered by the other enterprises can be used.

### BRIEF DESCRIPTION OF THE DRAWINGS

FIG. 1 is an overall configuration view of a spare part sharing system in the present embodiment and a block diagram of a server;

FIG. 2 is a diagram showing an example of the storage unit of the server 1n the present embodiment;

FIG. 3 is a diagram for illustrating a method of calculating the total values of spare parts in the present embodiment;

FIG. 4 is a diagram for illustrating a basic conception of the value management and the loan of the spare parts in the spare part sharing system in the present embodiment;

FIG. 5 is a flowchart showing the main processing of the server 1n the present embodiment;

FIG. 6 is a diagram showing a display example in a terminal in the present embodiment;

FIG. 7 is a flowchart showing the spare part registration processing of the server 1n the present embodiment;

FIG. 8 is a diagram showing a display example in the terminal in the present embodiment;

FIG. 9 is a diagram showing a display example in the terminal in the present embodiment;

FIG. 10 is a diagram showing a display example in the terminal in the present embodiment;

FIG. 11 is a flowchart showing the loan processing of the server 1n the present embodiment; and

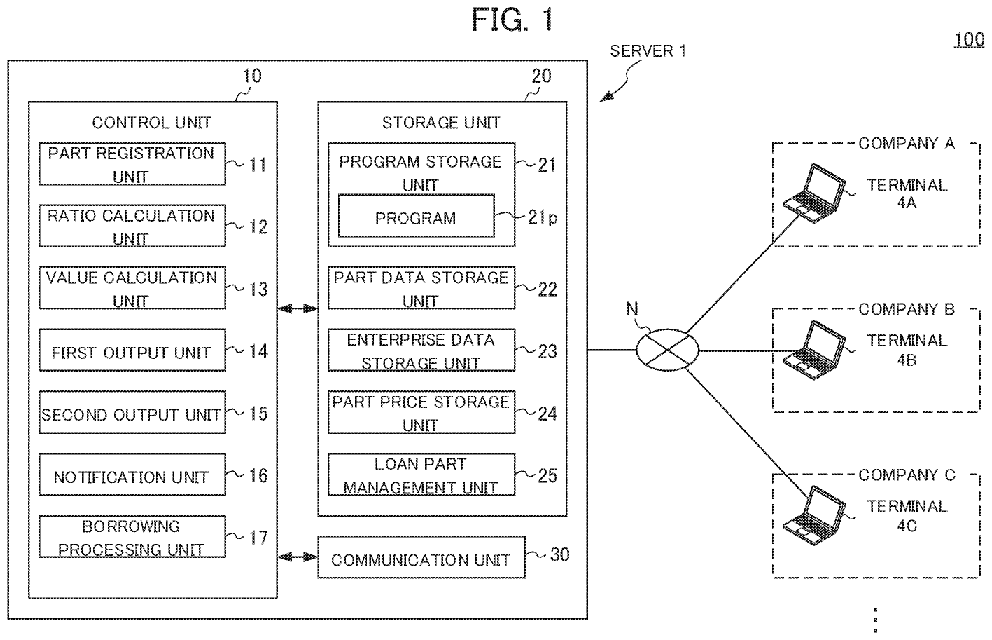

FIG. 1.2 is a diagram for illustrating storage unit updating processing in the server 1n the present embodiment.

### DETAILED DESCRIPTION OF THE INVENTION

### Embodiment

An outline of an embodiment of the present invention will first be described. The present embodiment relates to a system for managing the values of goods such that parts (devices and/or components) that serve as goods possessed (owned) by a plurality of enterprises (economic entities) and that are related to an industrial machine including a machine tool or an industrial robot are set as goods that can be used by other enterprises. More specifically, the present embodiment relates to a system (hereinafter referred to as a “spare part sharing system”) that manages spare parts (goods) possessed (owned) by a plurality of enterprises (economic entities) and that mediates in the loan of the spare parts between the enterprises based on the values of the managed spare parts.

The configuration of a spare part sharing system 100 in the present embodiment will be described. FIG. 1 is an overall configuration view of the spare part sharing system 100 in the present embodiment and a block diagram of a server 1. The spare part sharing system 100 includes the server 1 (serving as a value management server) and terminals 4 (4A, 4B, 4C, . . . ). The server 1 is operated and managed by a predetermined operating company. The terminals 4 (4A, 4B, 4C, . . . ) are terminals that are possessed by individual enterprises. The enterprises that possess the terminals are enterprises that use industrial machines such as a machine tool and an industrial robot. The terminal 4A is a terminal of a company A, and the terminals 4B and 4C are respectively terminals of a company B and a company C. Although in the spare part sharing system 100, each enterprise may use one or more terminals, only one terminal is shown in FIG. 1. In the following discussion, when the terminals 4A, 4B, 4C, . . . are not distinguished, a description will be simply given as the terminals 4.

The server 1 and the terminals 4 are connected together through a network N so as to be able to communicate with each other. The network N is, for example, the Internet, a VPN (Virtual Private Network), or a public telephone network. There is no limitation to a specific communication method in the network N, which one of a wired connection and a wireless connection is used, and the like.

### [Server 1]

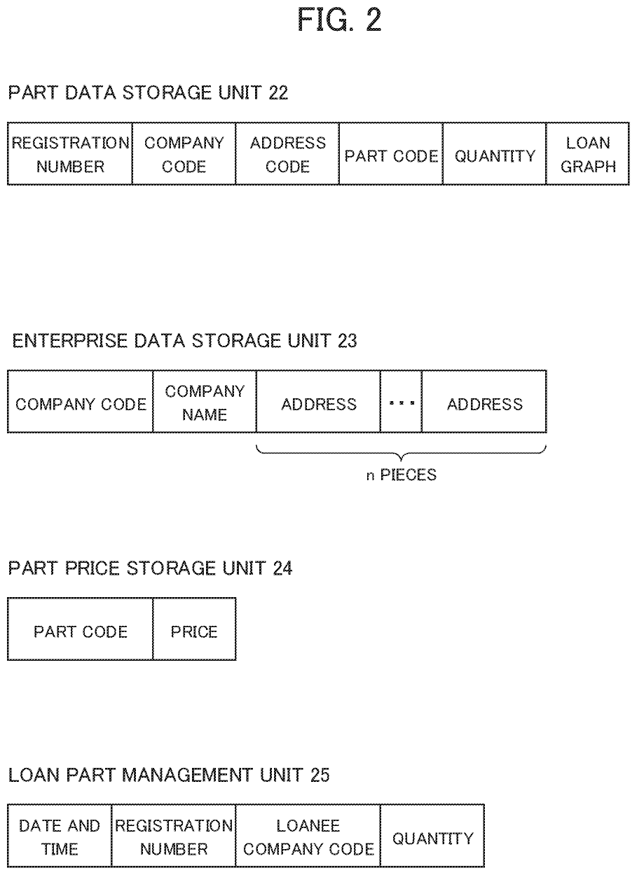

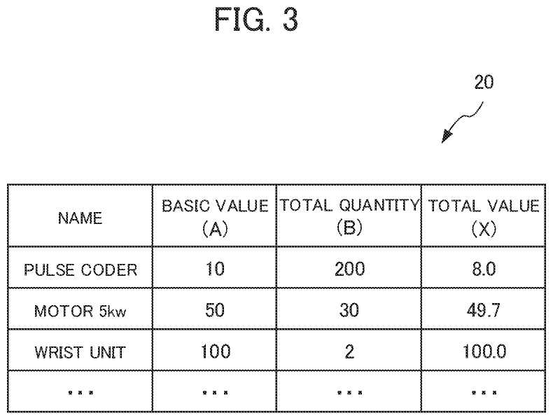

The server 1 will then be described. FIG. 2 is a diagram showing an example of a storage unit 20 of the server 1 in the present embodiment. FIG. 3 is a diagram for illustrating a method of calculating the total values of spare parts in the present embodiment. The server 1 collects and manages information on spare parts possessed by the individual enterprises so as to mediate in the loan of the spare parts between the enterprises. The spare parts refer to devices and/or components that are possessed by each enterprise and that serve as spare items. The devices and/or components are, for example, a pulse coder, a motor 5 kw, a wrist unit, a printed circuit board and an IC chip, and are used in industrial machines such as a machine tool and an industrial robot. The server 1 shown in FIG. 1 includes a control unit 10, the storage unit 20, and a communication unit 30. The control unit 10 may be a CPU (central processing unit), and executes various types of programs that are stored in the storage unit 20 and that control the server 1 so as to comprehensively control the server 1.

The storage unit 20 will first be described before the description of the individual function units of the control unit 10. The storage unit 20 is a storage de vice, such as a hard disk or a semiconductor memory element, that stores programs, data, and the like necessary for the operation of the server 1. The storage unit 20 includes a program storage unit 21, a part data storage unit 22, an enterprise data storage unit 23, a part price storage unit 24, and a loan part management unit 25. The program storage unit 21 is a storage region in which programs and the like executed by the control unit 10 are stored. The program storage unit 21 stores programs 21p for executing the individual function units of the control unit 10.

The part data storage unit 22 is a storage region in which information on the spare parts possessed by the enterprises is stored. As shown in FIG. 2, the part data storage unit 22 stores a registration number, a company code (serving as the identification information of an economic entity), an address code and a part code (serving as the identification information of a good), a quantity, and a loan flag so as to associate them with each other. The registration numbers are numbers that indicate the order in which parts are registered in the part data storage unit 22 and are, for example, serial numbers that are provided from 1 in the order of the registration. The company code is identification information for identifying the enterprise, and differs from enterprise to enterprise. The address code is identification information for identifying the address of a factory or the like that actually possesses the spare part. The part code is identification information for identifying the spare part. The spare part can be identified by the address code and the part code. The quantity is the numbers of spare parts that are input when the spare part is registered. The loan flag indicates whether or not the spare part is loaned and is set to “0” at the time of registration. Then, when the spare part is loaned, the loan flag is set to “1”. Except when all the registered quantity of spare parts are simultaneously loaned, it is likely that part of the registered quantity of spare parts are loaned and that the remaining quantity thereof are not loaned. In such a case, as will be described later, when the spare part is loaned, for the registration number of the spare part, for example, a branch number of the registration number is provided, whereby a record of the quantity of spare parts that are loaned is preferably divided.

The enterprise data storage unit 23 is a storage region in which the information of the individual enterprises is stored. The information of the individual enterprises stored in the enterprise data storage unit 23 is previously registered when the individual enterprises start to utilize the spare part sharing system 100. As shown in FIG. 2, the enterprise data storage unit 23 stores the company code, the company name, and n (n is a natural number) addresses so as to associate them with each other. In addition, the enterprise data storage unit 23 may store contact information (telephone number, e-mail address) and the like. The addresses are, for example, the locations of the headquarter of the enterprise, individual offices that possess spare parts, factories, and the like. The part price storage unit 24 is a storage region in which the prices of spare parts are stored. The part price storage unit 24 is previously registered. As shown in FIG. 2, the part price storage unit 24 stores the part code and the price so as to associate them with each other. The prices are, for example, market prices. The prices stored in the part price storage unit 24 are also referred to as basic prices in the following description.

The loan part management unit 25 is a storage region in which information on the loan of the part data stored in the part data storage unit 22 is stored. As shown in FIG. 2, the loan part management unit 25 stores a date and time, a registration number, a loanee company code, and a quantity so as to associate them with each other. The date and time is a date and time that is input when the spare part is loaned. The registration number corresponds to the registration number of the part data storage unit 22. The loanee company code is the company code of an enterprise that loans the spare part. The quantity is the number of spare parts that are loaned.

The storage unit 20 also stores a spare part table, an address table, and the like. The spare part table is a table in which the names of the spare parts and the part codes are associated with each other. In the spare part table, various types of specifications (such as specifications, failure occurrence rates, and management costs) of the spare parts may be stored. The address table is a table in which the addresses and the address codes are associated with each other. The individual storage units described above are examples.

The individual function units included in the control unit 10 shown in FIG. 1 will then be described. The control unit 10 includes a part registration unit 11, a ratio calculation unit 12, a value calculation unit 13, a first output unit 14, a second output unit 15, a notification unit 16, and a borrowing processing unit 17 (serving an IOU receiving unit and an IOU issuing unit). The part registration unit 11 receives spare part information input from the terminal 4, uses the tables such as the spare part table and the address table described above and the enterprise data storage unit 23 so as to convert the spare part information into codes, and stores them in the part data storage unit 22. The spare part information includes, for example, information on the names, the quantities, and the storage places of the spare parts.

The ratio calculation unit 12 calculates a ratio corresponding to the total quantity of the same spare part as a spare part registered by the part registration unit 11 in all the spare parts stored in the part data storage unit 22 and stores it in the storage unit 20. The ratio calculated by the ratio calculation unit 12 can be utilized as a ratio indicating the rarity of each spare part when the “total value” of the spare part that will be described later is calculated. As the ratio corresponding to the total quantity of the same spare part as the spare part registered by the part registration unit 11, for example, a value obtained by multiplying the total quantity of the spare part by 0.01 may be adopted. As will be described later, this ratio is subtracted from the value of the spare part, and thus it is possible to provide a configuration in which as the total quantity of the spare part is increased, the total value is lowered.

The value calculation unit 13 calculates the value of each spare part registered by the part registration unit 11. Specifically, as the value calculation unit 13, for example, a value calculation unit may be adopted that multiplies the market price of the spare part by a failure occurrence rate. In this way, the value of a spare part with a high failure occurrence rate can be calculated to be high for the reason that the frequency of use of the spare part is high. By contrast, the value of a spare part with a low failure occurrence rate can be calculated to be low for the reason that the frequency of use of the spare part is low. Hence, the value that is more suitable to the real situation can be calculated.

As another example of the value calculation unit 13, a value calculation unit may be adopted in which, on the market price, consideration is given to a management cost for storage of the spare part. For example, the management cost differs between a spare part that needs to be stored in a clean room and a spare part that is stored in a warehouse. Since an extra management cost is needed for the spare part that needs to be stored in a clean room, the value of the spare part can be calculated to be high. The value calculation unit 13 is not limited to these examples. The market price of a good may be adopted as the value of the good without being changed. Based on the specifications and the like of a spare part, a calculation method may be arbitrarily set.

As described previously, in the value calculation unit 13, the “total value” that is a relative value with consideration given to the total quantity of the same spare part as the spare part registered by the part registration unit 11 may be calculated. The value with consideration given to the total quantity of the same spare part is particularly referred to as the “total value”. By contrast, the value described above that is determined by the specifications and the like of the spare part itself is referred to as a “basic value”. In the following description, when the “basic value” and the “total value” are not distinguished, they are simply referred to as the “value”.

Specifically, as the value calculation unit 13 that calculates the “total value,” the following example can be mentioned. In the value calculation unit 13, for example, assuming that the basic value is A and that the total quantity of the same spare part is B, the following formula is used as a predetermined formula, and thus the total value X that is the value of one registered spare part may be calculated.

X=A−B×0.01 (formula 1)

Here, “B×0.01” is the ratio that is calculated by the ratio calculation unit 12 and is stored in the storage unit 20. (Formula 1) is an example, and the formula for calculating the total value X that is the value of one registered spare part is not limited to this formula. The formula may be set as necessary according to the specifications and the like of a good.

FIG. 3 shows, for the individual spare parts, examples of the total value X calculated by (formula 1) described above. For example, in a “pulse coder” that is one of the spare parts, the basic value A is 10, and the total quantity B is 200. Then, the value calculation unit 13 calculates the total value K of the “pulse coder” by application to (formula 1) such that the total value X is 8.0. In a “wrist unit” that is one of the spare parts, the basic value A is 100, and the total quantity B is 2. Then, the value calculation unit 13 calculates the total value X of the “wrist unit” by application to (formula 1) such that the total value X is 100.0. As described above, as the total quantity B is increased, the total value X is lowered with respect to the basic value A. This is because the total value X of a rare spare part is set unchanged with respect to the basic value A, whereas the total value X of a spare part registered in large quantity is set lower than the basic value A. The value calculation unit 13 described above that calculates the “total value” is not limited to this example. As long as the total value of a rare spare part is increased, another calculation method may be adopted.

The first output unit 14 outputs the value calculated by the value calculation unit 13 to the terminal 4 that inputs the spare part information. The first output unit 14 may output the value of the spare part registered by the part registration unit 11. The first output unit 14 may also output a usable value obtained by summing up the values of individual spare parts, including already registered spare parts, that are registered by the enterprise as a usable value owned by the enterprise. The second output unit 15 outputs information on the spare parts stored in the part data storage unit 22 to all the terminals 4. The information output by the second output unit 15 is information that is registered in the spare part sharing system 100 and that is related to the spare parts that can be loaned by the individual enterprises.

When the notification unit 16 receives a usage request from an enterprise (hereinafter also referred to as a “loanee enterprise”) that desires to use a spare part, that is, that desires to receive the loan of a spare part, the notification unit 16 provides notification to the terminal 4 of an enterprise (hereinafter also referred to as a “loaner enterprise”) that possesses the spare part and that loans it. Here, the notification unit 16 receives the usage request within the range of a usable value possessed by the loanee enterprise. When the loan of the spare part is established, the borrowing processing unit 17 performs, between the terminal 4, processing such as support for producing an IOU and the delivery thereof. The communication unit 30 is a communication control device that transmits and receives data to and from the terminal 4.

### [Terminal 4]

The terminal 4 is, for example, a personal computer (PC) that is owned by each enterprise. The terminal 4 may be a portable terminal such as a tablet terminal or a smartphone. The terminal 4 includes a control unit, a storage unit, an input unit, a display unit, a communication unit, and the like (all of which are not shown). Each enterprise uses the terminal 4 to communicate with the server 1, and thereby performs various types of processing such as the registration of spare parts, the inquiry of spare parts, and the loan of spare parts that will be described later.

The devices included in the spare part sharing system 100 described above can be individually realized by hardware, software or a combination thereof. Here, the realization by software means that a computer reads and executes programs (applications) so as to achieve the realization. As a specific example, the server 1 can be realized by incorporating programs (applications) for realizing the present embodiment into a general server.

### [Schematic Description]

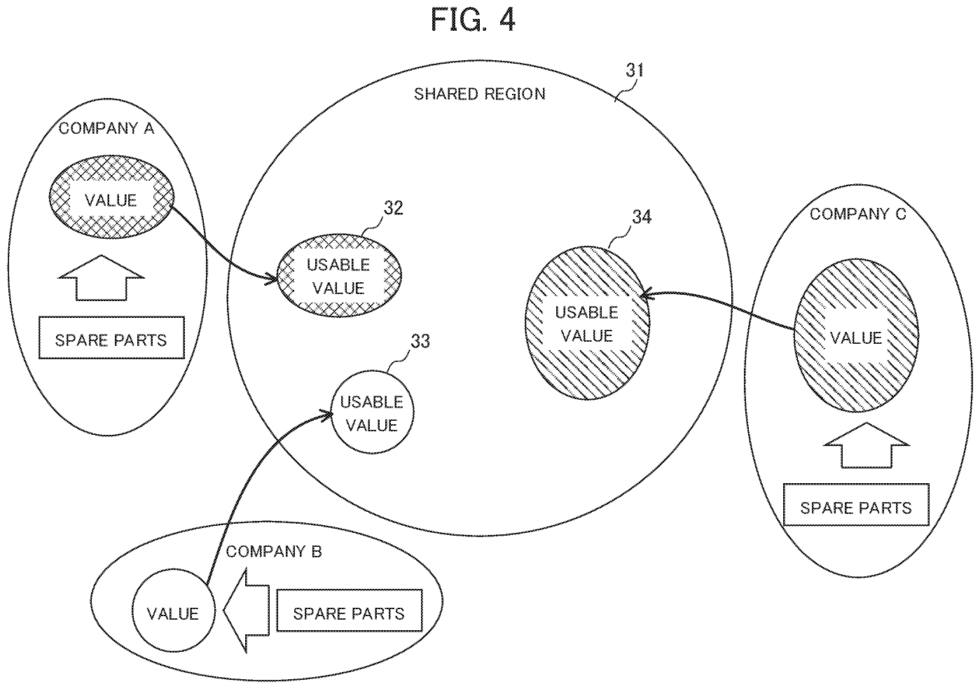

A basic way of thinking about the value management and the loan of spare parts in the spare part sharing system 100 will then be described. FIG. 4 is a diagram for illustrating a basic conception of the value management and the loan of spare parts in the spare part sharing system 100 in the present embodiment. It is assumed that the company A, the company B, and the company C shown in FIG. 4 have each registered possessed spare parts in the server 1. The control unit 10 of the server 1 calculates the values of individual spare parts registered and sets values determined by multiplying the values by the quantities of the spare parts registered by each enterprise to a usable value for the enterprise. FIG. 4 shows the usable values of the spare parts registered by the individual enterprises.

In a shared region 31, value regions 32, 33, and 34 of the individual enterprises are shown. The values of all the spare parts registered by the company A are shown as a usable value in the value region 32. The values of all the spare parts registered by the company B are shown as a usable value in the value region 33, and the values of all the spare parts registered by the company C are shown as a usable value in the value region 34. Here, the calculated values do not identify the spare parts. By the sizes of the value regions 32, 33, and 34, the magnitudes of the usable values are found. Each enterprise can receive the loan of spare parts possessed by the other enterprises within the range of the usable value of the spare parts registered by the enterprise. For example, since the usable value of the company A is larger than the usable value of all the spare parts registered by the company B, if the company A receives the loan of all the spare parts registered by the company B, the company A can receive the loan of all the spare parts. However, by contrast, even if the company B receives the loan of all the spare parts registered by the company A, the company B can receive the loan of spare parts only within the range of the usable value of the spare parts registered by the company B among the spare parts registered by the company A.

The usable values of the individual enterprises indicated by the value regions 32, 33, and 34 are not proportional to the numbers of registered spare parts. As described previously, as the basic price of the registered spare part is increased, the value tends to be increased. Furthermore, a configuration may be adopted in which as the failure occurrence rate of the part is increased, the frequency of use thereof is increased, and in which thus the value thereof is increased. Furthermore, a configuration may be adopted in which as the management cost of the part is increased, the value thereof is increased. As the value, the “total value” is applied, and thus when the registered spare parts are not registered by other enterprises, the spare parts are rare, whereby the values thereof can be increased. The values are increased, and thus the usable value obtained by summing up these values is increased.

### [Description of Processing]

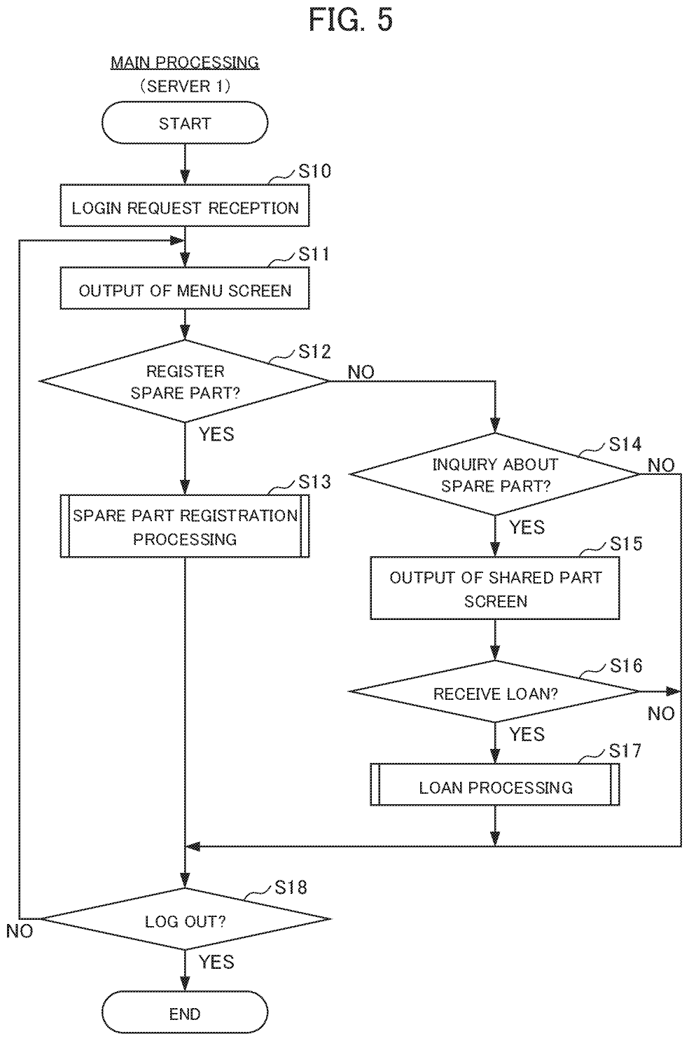

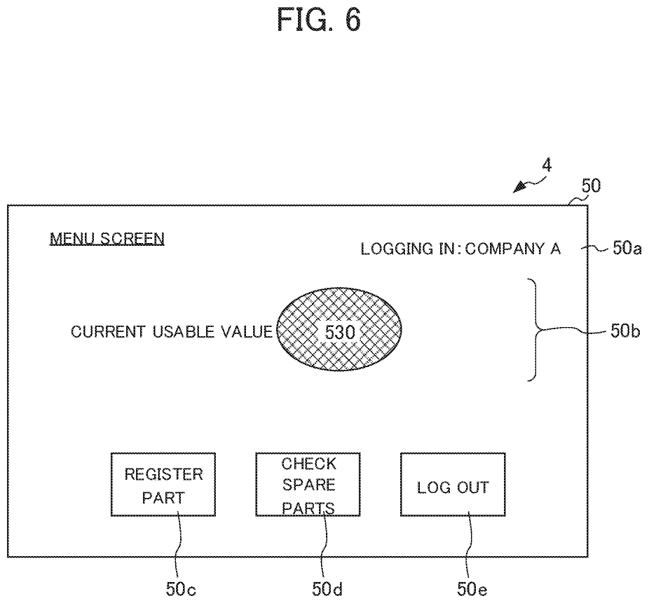

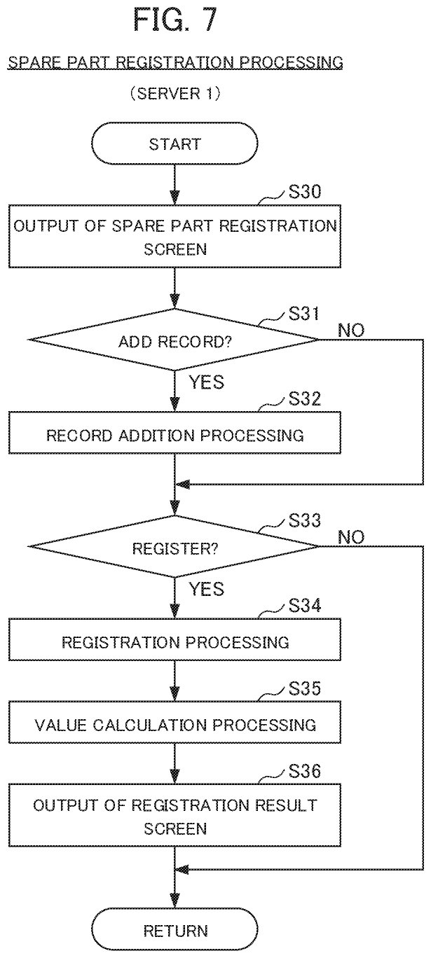

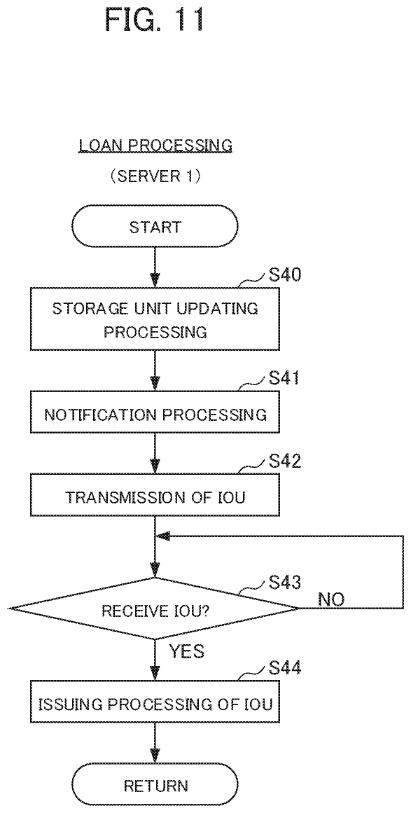

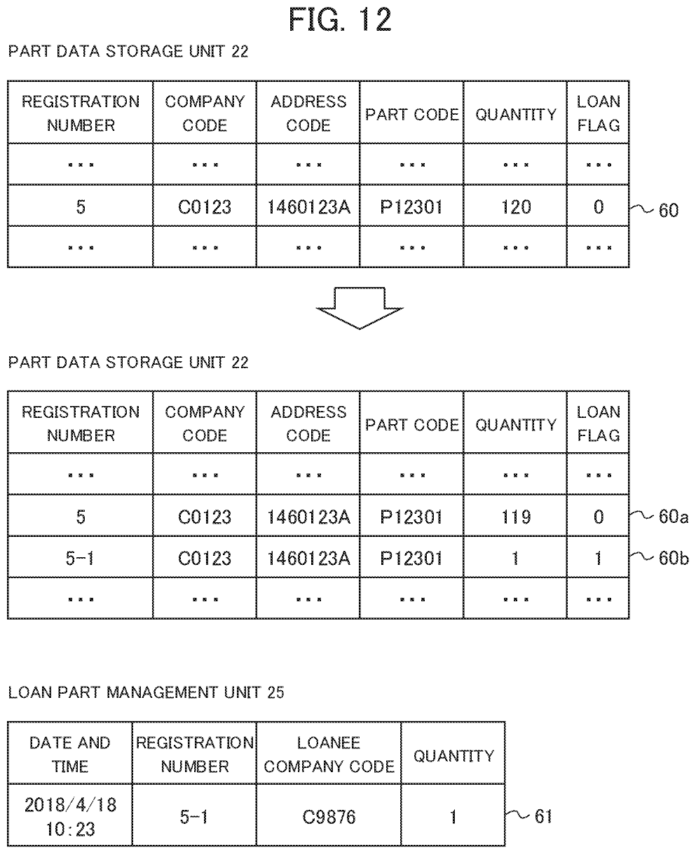

Processing in the server 1 will then be described. FIG. 5 is a flowchart showing the main processing of the server 1 in the present embodiment. FIGS. 6 and 8 to 10 are diagrams showing display examples in the terminal 4 in the present embodiment, FIG. 7 is a flowchart showing the spare part registration processing of the server 1 in the present embodiment. FIG. 11 is a flowchart showing the loan processing of the server 1 in the present embodiment. FIG. 12 is a diagram for illustrating storage unit updating processing in the server 1n the present embodiment.

The server 1 and the terminal 4 are first connected together so as to communicate with each other, for example, in the terminal 4, the user of the terminal 4 inputs login information from the initial screen that is not shown so as to start login, and thus in S10 of FIG. 5, the control unit 10 of the server 1 receives a login request.

In S11, the control unit 10 performs authorization, and when the authorization is achieved, the control unit 10 (the first output unit 14) outputs, for example, a menu screen 50 shown in FIG. 6 to the terminal 4. The menu screen 50 includes a login display region 50a, a value display region 50b, and buttons 50c to 50e. The login display region 50a indicates that the company A logs in. The value display region 50b displays, as the usable value, the values of all the spare parts registered by the company A. The buttons 50c to 50e are buttons that receive a selection operation so as to perform the subsequent processing. The button 50c is used when a spare part is registered. The button 50d is used when the loan of a spare part is desired to be received. The button 50e is used when logout is performed.

In S12 of FIG. 5, the control unit 10 determines whether or not a spare part is to be registered. When the button 50c is selected on the menu screen 50 described above, the control unit 10 determines that the spare part is registered. When the spare part is registered (S12: yes), the control unit 10 transfers the processing to S13. On the other hand, when the spare part is not registered (512: no), the control unit 10 transfers the processing to S14. In S13, the control unit 10 (the part registration unit 11) performs spare part registration processing.

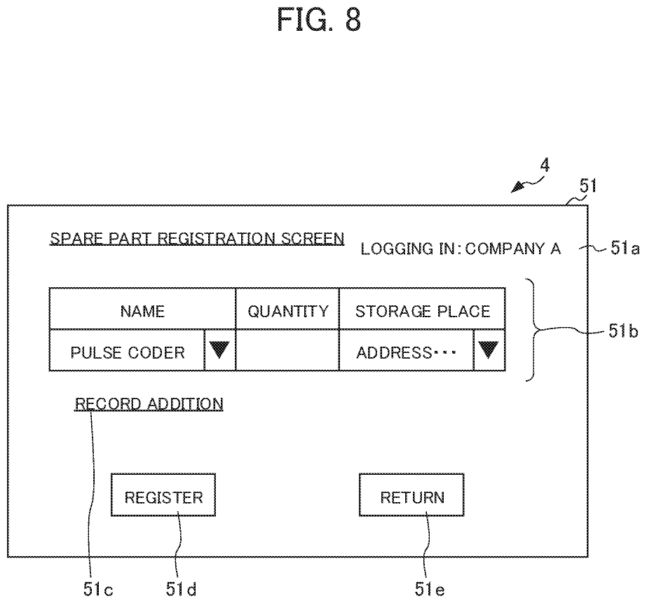

Here, the spare part registration processing will be described with reference to FIG. 7. In S30 of FIG. 7, the control unit 10 outputs, for example, a spare part registration screen 51 shown in FIG. 8 to the terminal 4. The spare part registration screen 51 includes a login display region 51a, a detail input region 51b, a link unit 51c and buttons 51d and 51e. The login display region 51a indicates that the company A logs in. The detail input region 51b is a region in which the name, the quantity, and the storage place of the spare part are input. The detail input region 51b may be configured such that the spare part and the storage place can be simply input, for example, by selection from a pull-down list. The link unit 51c is used when a plurality of details need to be input. When the link unit 51c is selected, a record is added in the detail input region 51b in a downward direction, and thus the input of another spare part can be performed. The buttons 51d and 51e are buttons that receive a selection operation so as to perform the subsequent processing. The button 51d is used when the spare part is registered. The button 51e is used when the spare part is not registered.

In S31 of FIG. 7, the control unit 10 determines whether or not the record is to be added. For example, when on the spare part registration screen 51 shown in FIG. 8 the selection of the link unit 51c is received, the control unit 10 determines that the record is added. When the record is added (831: yes), the control unit 10 transfers the processing to S32. On the other hand, when the record is not added (S31: no), the control unit 10 transfers the processing to S33. In S32, the control unit 10 performs record addition processing for adding the record to the detail input region 51b. A configuration may be adopted in which the addition of a plurality of records can be performed. In $33, the control unit 10 determines whether or not the spare part input into the detail input region 51b is to be recorded. For example, when the selection of the button 51d shown in FIG. 8 is received, the control unit 10 determines that the spare part is recorded. When the spare part is recorded (S33: yes), the control unit 10 transfers the processing to S34. On the other hand, when the spare part is not recorded (833: no), the control unit 10 completes the present processing and transfers the processing to S18 in FIG. 5. The case where the spare part is not recorded refers to, for example, a case where the selection of the button 51e is received.

In S34, the control unit 10 (the part registration unit 11) performs registration processing. Specifically, the control unit 10 registers the information on the spare part input into the detail input region 51b shown in FIG. 8 in the part data storage unit 22. Here, the control unit 10 acquires a part code corresponding to the name and an address code corresponding to the input storage place from the tables that are not shown and registers them. In S35, the control unit 10 (the value calculation unit 13) calculates the value of the registered spare part. When the “total value” is applied as the value, as described previously, for example, the control unit 10 adds the total quantity of individual spare parts registered to the original total quantity and then applies the result to (formula 1) so as to calculate the total value.

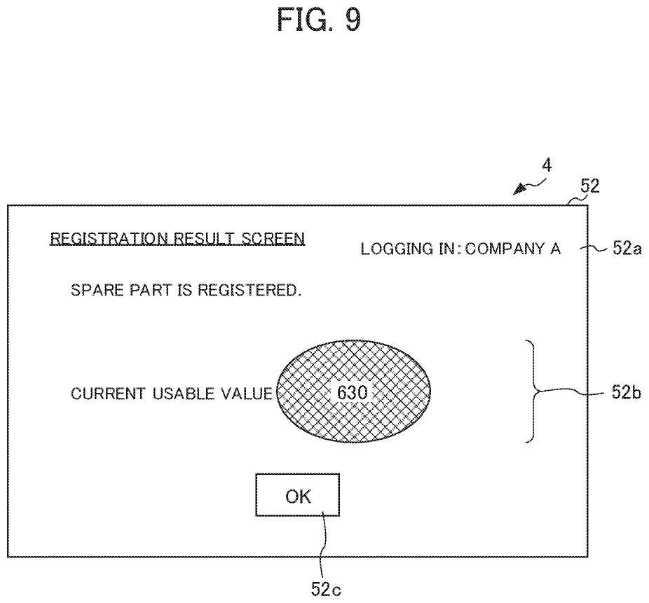

In S36, the control unit 10 (the first output unit 14) outputs, for example, a registration result screen 52 shown in FIG. 9 to the terminal 4. The registration result screen 52 includes a login display region 52a, a value display region 52b, and a button 52c. The login display region 52a indicates that the company A logs in. The value display region 52b displays, as the usable value, the values of all the spare parts registered by the company A. As compared with the menu screen 50 of FIG. 6, the value of the spare parts displayed in the value display region 52b is increased by the value resulting from the registration of the spare part. The button 52c receives a selection operation so as to perform the subsequent processing. The button 52c is used when the registration result screen 52 is confirmed. Thereafter, the control unit 10 completes the present processing and transfers the processing to S18 of FIG. 5.

A description will be given with reference back to FIG. 5. In S14 of FIG. 5, the control unit 10 determines whether or not an inquiry about the spare part is to be made. When on the menu screen 50 shown in FIG. 6 and the selection of the button 50d is received, the control unit 10 determines that the inquiry about the spare part is made. When the inquiry about the spare part is made (S14: yes), the control unit 10 transfers the processing to S15. On the other hand, when the inquiry about the spare part is not made (S14: no), the control unit 10 transfers the processing to S18.

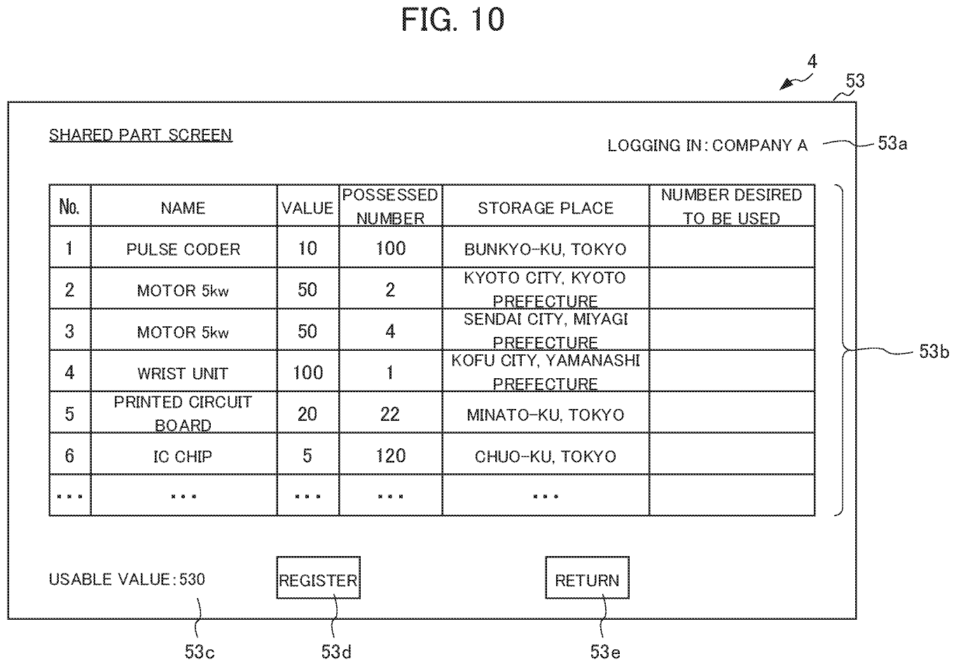

In S15, the control unit 10 (the first output unit 14, the second output unit 15) outputs, for example, a shared part screen 53 shown in FIG. 10 to the terminal 4. The shared part screen 53 includes a login display region 53a, a detail list region 53b, a value display region 53c, and buttons 53d and 53e. The login display region 53a indicates that the company A logs in. The detail list region 53b displays, as a list, all the spare parts registered as shared spare parts (shared goods) by the individual enterprises on an individual basis for the names and the storage places. In this example, as the storage places, only cities, wards, towns, and villages are displayed, and thus places cannot be identified. In the detail list region 53b, the number of spare parts desired to be used can be input. The value display region 53c displays the value that can be utilized by the enterprise (in this example, the company A) that logs in. The buttons 53d and 53e are buttons that receive a selection operation so as to perform the subsequent processing.

The user of the terminal 4 checks, from the list of the detail list region 53b, whether or not the spare part desired to be loaned is present, and when the spare part desired to be loaned is present, the user checks the quantity and the storage place. Here, the user preferably looks for a spare part in a storage place close to a facility that desires to receive the loan of the spare part. The spare part is delivered from the storage place to a destination specified by the loanee enterprise. Hence, in order to reduce a cost and time for the delivery, it is preferable to look for the storage place close to the destination specified by the loanee enterprise. Then, when the record of the spare part desired to be loaned is found, the user of the terminal 4 inputs the quantity of the spare part to be loaned into the number of spare parts desired to be used in the record and selects the button 53d. Here, the user of the terminal 4 checks, with reference to the usable value displayed in the value display region 53c, whether or not the value of the spare part desired to be used falls within the range of the usable value and inputs the usage request. A configuration may be adopted in which the control unit 10 determines whether or not the value is usable based on the value of the spare part where the number of spare parts desired to be used is input and the usable value, and only when the value is usable the button 53d is enabled.

In S16 of FIG. 5, the control unit 10 determines whether or not the loan of the spare part is to be received, that is, whether or not the spare part is desired to be used. When the selection of the button 53d shown in FIG. 10 is received, the control unit 10 determines that the loan of the spare part is received. When the loan of the spare part is received (S16: yes), the control unit 10 transfers the processing to S17. On the other hand, when the loan of the spare part is not received (816: no), the control unit 10 transfers the processing to S18. The case where the use is not desired refers to, for example, a case where the selection of the button 53e shown in FIG. 10 is received. In S17, the control unit 10 performs loan processing.

Here, the loan processing will be described with reference to FIG. 11. In S40 of FIG. 11, the control unit 10 performs the storage unit updating processing. Specifically, the control unit 10 updates the loan flag of the record that is a loan target from “0” to “1” among records stored in the part data storage unit 22. When the quantity in the record is plural and is larger than the quantity to be loaned, if the loan flag of the record that is the loan target is updated from “0” to “1”, all the spare parts are loaned, whereby it is not preferable to do so. Hence, as shown in FIG. 12, a record 60 is divided into two records 60a and 60b. Then, a branch number is provided to the newly produced record 60b, and the quantity to be loaned is subtracted from the registered quantity in the original record 60a. As shown in FIG. 12, the control unit 10 adds a record 61 to the loan part management unit 25 and inputs predetermined values into individual items.

In S41 of FIG. 11, the control unit 10 (the notification unit 16) notifies the loaner enterprise of information that the loan is received. The control unit 10 may provide the notification such as by e-mail or may display, as a notification item, on the menu screen of the spare part sharing system 100 or the like. In S42, the control unit 10 (the borrowing processing unit 17) transmits, for example, a template of an IOU to the loanee enterprise. In the template of the IOU, items for identifying enterprises such as the names of the loaner enterprise and the loanee enterprise are not described. This is because the names of the enterprises and the like are hidden for both the enterprises such that concealment is ensured. The loanee enterprise utilizes the template of the IOU received so as to produce an IOU and transmits it to the server 1.

In S43, the control unit 10 determines whether or not the IOU is received from the loanee enterprise. When the IOU is received (S43: yes), the control unit 10 transfers the processing to S44. On the other hand, when the IOU is not received (S43: no), the control unit 10 stays in the present processing until the reception of the IOU. In S44, the control unit 10 (the borrowing processing unit 17) produces the IOU so as to issue it to the loaner enterprise. Thereafter, the control unit 10 transfers the processing to S18 of FIG. 5.

In S18 of FIG. 5, the control unit 10 receives an operation for logging out so as to determine whether or not logout is to be performed. When the logout is performed (S18: yes), the control unit 10 completes the present processing. On the other hand, when the logout is not performed (S18: no), the control unit 10 transfers the processing to S11.

The loanee enterprise that receives the loan is obliged to purchase the same part as the spare part loaned so as to return it. In this way, the loan flag of the part data storage unit 22 is changed to “0”, and thus the loan state is cancelled such as by deletion of the corresponding record from the loan part management unit 25.

As described above, in the spare part sharing system 100, the server 1 manages the spare parts of the individual enterprises and mediates in the loan processing. Hence, each enterprise utilizes the spare part sharing system 100 so as to be able to receive, from other enterprises, the loan of the spare parts that are not possessed by the enterprise. Consequently, the enterprise can receive the spare parts earlier than the enterprise orders and waits for them. The mechanism described above is established, and thus it is possible to provide an opportunity to resister the spare parts possessed by each enterprise in the server 1. The loan can be performed within the range of the usable value of the spare parts registered by each enterprise, and thus it is possible for each enterprise to be provided an opportunity to possess a certain number of spare parts.

When the “total value” is applied as the value of the spare part, it corresponds to the total quantity of the same spare part as the registered spare part among all the spare parts registered as spare parts. Hence, the total value of the spare part in which a small number of spare parts are registered can be increased.

Furthermore, since concealment is ensured for provision of the IOU, the loan of a spare part can be performed without internal information related to the manufacturing of a product in each enterprise being noticed.

The programs used in the present invention are stored with various types of non-transitory computer readable media and can be supplied to a computer. The non-transitory computer readable media include various types of tangible storage media. Examples of the non-transitory computer readable media include magnetic recording media (for example, a flexible disk, a magnetic tape, and a hard disk drive), magneto-optical recording media (for example, a magneto-optical disc), a CD-ROM (Read Only Memory), a CD-R, a CD-R/W, and semiconductor memories (for example, a mask ROM, and a PROM (program able ROM), an EPROM (Erasable PROM), a flash ROM, and a RAM (random access memory)). The programs may also be supplied to the computer with various types of transitory computer readable media. Examples of the transitory computer readable media include an electrical signal, an optical signal, and electromagnetic waves. The transitory computer readable media can supply the programs to the computer through a wired communication path such as an electric wire or an optical fiber or a wireless communication path.

Although the embodiment described above is a preferred embodiment of the present invention, the scope of the present invention is not limited to only the embodiment described above, and various modifications are made without departing from the spirit of the present invention such that the present invention can be practiced.

### (Variation 1)

Although in the embodiment discussed above the description is given of the example where the user who wants to receive the loan of a spare part desires to use the spare part stored in a storage place close to a place in which the spare part is needed by the enterprise of the user, there is no limitation to this configuration. For example, a configuration may be adopted in which the place where the spare part is needed by the enterprise of the user is input such as by selection and in which thus a spare part stored in a storage place close thereto is selected by the server or is output to a position where the spare part is easy to see.

### (Variation 2)

Although in the description of the embodiment discussed above the enterprise serving as the economic entity utilizing the spare part sharing system 100 is an enterprise using an industrial machine, there is no limitation to this description. For example, specialists such as a system integrator and an MTB may be included.

### EXPLANATION OF REFERENCE NUMERALS

1 server
4 terminal
10 control unit
11 part registration unit
12 ratio calculation unit
1.3 value calculation unit
14 first output unit
15 second output unit
16 notification unit
17 borrowing processing unit
20 storage unit
20p program
22 part data storage unit
23 enterprise data storage unit
24 part price storage unit
25 loan part management unit
100 spare part sharing system

What is claimed is:

1. A value management server that registers devices and/or components possessed by a plurality of economic entities as goods that can be used by all the economic entities and that manages the devices and/or components, the value management server comprising:
a storage unit that stores at least identification information of the registered economic entities and identification information and quantities of the registered goods;
a value calculation unit that calculates, based on at least the identification information of the registered goods, values of the registered goods;
a first output unit that outputs the values calculated by the value calculation unit as usable values of the registered economic entities to the registered economic entities; and
a second output unit that outputs the goods that are stored in the storage unit and that are registered as shared goods by all the economic entities.

2. The value management server according to claim 1 comprising: a ratio calculation unit that calculates a ratio corresponding to a quantity of a good having the same identification information as the registered good in the goods registered as the shared goods by all the economic entities,
wherein the value calculation unit calculates the value of the registered good from at least the identification information of the registered good and the ratio.

3. The value management server according to claim 1, wherein the storage unit further stores information on storage places of the registered goods, and
the second output unit further outputs the information on the storage places of the goods.

4. The value management server according to claim 1 comprising: a notification unit that provides, when a usage request for the good is received from the economic entity that desires to use the good, notification to the economic entity that possesses the good.

5. The value management server according to claim 4, wherein the notification unit provides the notification to the economic entity that possesses the good on condition that the value of the good for that the usage request received does not exceed the usable value of the goods possessed by the economic entity that desires to use the good.

6. The value management server according to claim 1, wherein a usage request for the good from the economic entity that possesses the good to the economic entity that desires to use the good is a loan of the good from the economic entity that possesses the good to the economic entity that desires to use the good.

7. The value management server according to claim 1, wherein the economic entity that possesses the good and the economic entity that desires to use the good are made to conceal each other.

8. The value management server according to claim 7 comprising: an IOU receiving unit that receives, from the economic entity that desires to use the good, an IOU for the good.

9. The value management server according to claim 8 comprising: an IOU issuing unit that issues the IOU to the economic entity that possesses the good.

10. A value management method of using a computer so as to register devices and/or components possessed by a plurality of economic entities s goods that can be used by all the economic entities and to manage the devices and/or components, the value management method comprising:
a storage step of storing at least identification information of the registered economic entities and identification information and quantities of the registered goods;
a value calculation step of calculating, based on at least the identification information of the registered goods, values of the registered goods;
a first output step of outputting the values calculated in the value calculation step as usable values of the registered economic entities to the registered economic entities; and
a second output step of outputting the goods that are stored in the storage step and that are registered as shared goods by all the economic entities, wherein all the steps are performed by the computer.

11. A non-transitory computer readable medium recording a program that makes a computer function as:
a storage means that stores at least identification information and quantities of goods where devices and/or components possessed by a plurality of economic entities are registered as the goods that can be used by all the economic entities and identification information of the economic entities that register the goods;
a value calculation means that calculates, based on at least the identification information of the registered goods, values of the registered goods;
a first output means that outputs the values calculated by the value calculation means as usable values of the registered economic entities to the registered economic entities; and
a second output means that outputs the goods that are stored in the storage means and that are registered as shared goods by all the economic entities.
